(19) United States
(12) Patent Application Publication
(10) Pub. No.: US 2026/0331719 A1
(43) Pub. Date: Oct. 22, 2026

(54) CONNECTION STRUCTURE, COVER ASSEMBLY AND BATTERY

(71) Applicants: HUIZHOU EVE POWER CO., LTD, Tonghu Town, Guangdong (CN); EVE POWER CO., LTD., Jingmen, Hubei (CN)

(72) Inventors: Kuanjin SHU, Guangdong (CN); Dong DUAN, Guangdong (CN); Ziwen LIU, Guangdong (CN); Wei HE, Guangdong (CN)

(73) Assignees: HUIZHOU EVE POWER CO., LTD, Tonghu Town, Guangdong (CN); EVE POWER CO., LTD., Jingmen, Hubei (CN)

(21) Appl. No.: 19/692,404

(22) Filed: May 29, 2026

Related U.S. Application Data
(63) Continuation of application No. PCT/CN2024/111758, filed on Aug. 13, 2024.

(30) Foreign Application Priority Data
Nov. 30, 2023 (CN) 202323266000.X

(51) Int. Cl. H01M 50/533; H01M 50/103; H01M 50/15; H01M 50/16; H01M 50/536; H01M 50/55; H01M 50/557

(52) U.S. Cl. CPC H01M 50/533; H01M 50/103; H01M 50/15; H01M 50/16; H01M 50/536; H01M 50/55; H01M 50/557

(57) ABSTRACT

A connection structure, a cover assembly and a battery are provided. The connection structure includes a tab connection portion and a pole connection portion that are bend-connected. One side of the tab connection portion adjacent to the pole connection portion is arranged facing a core pack. One side of the tab connection portion facing away from the pole connection portion is configured to be welded with a tab protruding from the core pack. The pole connection portion is configured to connect a pole of the core pack. A thickness of the tab connection portion is greater than a thickness of the pole connection portion, so that a distance from the tab welded to the tab connection portion to a side surface of the core pack where the tab is located is greater than the thickness of the pole connection portion.

### RELATED APPLICATION(S)

The present disclosure is a continuation application of International application No. PCT/CN2024/111758, filed on Aug. 13, 2024, which claims priority to Chinese Patent Application No. 202323266000.X, filed on Nov. 30, 2023. The entire disclosure of the prior applications is hereby incorporated by reference.

### TECHNICAL FIELD

The present disclosure relates to the field of battery technologies, and in particular, to a connection structure, a cover assembly, and a battery.

### BACKGROUND

A battery mainly includes a housing with an opening, a cover assembly sealing the opening, and a core pack arranged inside the housing. The side surface of the core pack is provided with a tab. The side surface of the core pack where the tab is located is arranged at an angle to the cover assembly. The cover assembly includes a top cover and a pole provided on the top cover. The pole and the tab are connected by an L-shaped connection piece. The connection piece includes a tab connection portion and a pole connection portion that are vertically arranged. The pole connection portion is arranged parallel to the top cover and is welded to the pole, while the tab connection portion is located at one side of the core pack and is welded to the tab.

However, existing connection pieces are uniformly thick. To prevent the heat generated during welding between the tab connection portion and the tab from easily transferring to the core pack and avoid core pack burns that could lead to short circuits, the tab connection portion needs to be thickened. However, thickening the tab connection portion also results in thickening the pole connection portion, which reduces the dimensional utilization in the height direction and decreases the battery capacity.

### SUMMARY

The present disclosure provides a connection structure for connecting a core pack and a pole of a battery. The connection structure includes a tab connection portion and a pole connection portion that are bend-connected. One side of the tab connection portion adjacent to the pole connection portion is arranged facing the core pack. One side of the tab connection portion facing away from the pole connection portion is configured to be welded with a tab protruding from the core pack. The pole connection portion is configured to connect the pole. A thickness of the tab connection portion is greater than a thickness of the pole connection portion, so that a distance from the tab welded to the tab connection portion to a side surface of the core pack where the tab is located is greater than the thickness of the pole connection portion.

### BRIEF DESCRIPTION OF THE DRAWINGS

FIG. 1 is a perspective view of a battery according to the present disclosure, excluding a housing.

FIG. 2 is an exploded assembly view of the battery according to the present disclosure, excluding the housing.

FIG. 3 is a cross-sectional view of the battery according to the present disclosure.

FIG. 4 is an enlarged view of the structure at position A in FIG. 3.

FIG. 5 is a perspective view of a connection structure according to the present invention.

FIG. 6 is a first side view of the connection structure according to the present disclosure.

FIG. 7 is an enlarged view of the structure at position B in FIG. 6.

FIG. 8 is a second side view of the connection structure according to the present disclosure.

FIG. 9 is an enlarged view of the structure at position C in FIG. 8.

### REFERENCE NUMERALS IN THE FIGURES

1, tab connection portion; 11, first substrate; 12, first plate; 13, heat insulation cavity; 2, pole connection portion; 21, second substrate; 22, second plate; 23, fuse hole; 3, opening; 4, convex structure;
100, connection structure; 200, cover body; 300, pole; 400, plastic member; 401, receiving groove; 500, core pack; 501, tab; 5011, first segment; 5012, second segment; 502, insertion slot; 600, insulating sheet; 700, housing; 800, cover assembly; 1000, battery.

### DETAILED DESCRIPTION

At present, the battery mainly uses a L-shaped connection pieces to connect to a pole and a tab to realize a charging and discharging function of the battery. The connection piece includes a tab connection portion and a pole connection portion that are vertically arranged. The pole connection portion is arranged parallel to a top cover and is welded to the pole, while the tab connection portion is located at one side of the core pack and is welded to the tab. Because the tab protruding from the side surface of the core pack occupies an internal space of the battery, the utilization rate of the internal space of the battery is reduced, and the battery capacity is reduced.

As shown in FIG. 1 to FIG. 4, a battery 1000 provided in the present disclosure includes a housing 700 having an opening, a core pack 500 arranged inside the housing 700, and a cover assembly 800. The cover assembly 800 is configured to be sealed on the opening. The core pack 500 is provided with a tab 501. The cover assembly 800 includes a cover body 200, a pole 300 and a connection structure 100. The cover body 200 is arranged at an angle with a side surface of the core pack 500 where the tab 501 is located. The pole 300 is mounted on the cover body 200. The connection structure 100 is respectively connected to the pole 300 and the tab 501.

Specifically, the tab 501 includes a first segment 5011 and a second segment 5012 that are bend-connected. One end of the first segment 5011 away from the second segment 5012 is connected to the core pack 500. The core pack 500, the first segment 5011 and the second segment 5012 together form an insertion slot 502. Please refer to FIG. 1 to FIG. 5 together, the connection structure 100 includes a tab connection portion 1 and a pole connection portion 2 that are bend-connected. The tab connection portion 1 is inserted into the insertion slot 502 and is welded to the second segment 5012, and the tab connection portion 1 is arranged insulated from the core pack 500, to avoid short circuit damage of the core pack 500. The tab 501 is bent and welded to the tab connection portion 1, which helps reduce the length of the tab 501 protruding from a connection surface of the core pack 500, thereby minimizing the space occupied by the tab 501 inside the housing 700. Additionally, after bending, the tab 501 forms the insertion slot 502 that engages with the tab connection portion 1, this allows the tab connection portion 1 to be positioned between the second segment 5012 of the tab 501 and the connection surface of the core pack 500, preventing the tab connection portion 1 from protruding outward beyond the second segment 5012 and occupying additional space inside the housing 700. As a result, this design effectively reduces the space occupied by both the tab 501 and the tab connection portion 1 inside the housing 700, improving the spatial utilization within the housing 700 and contributing to increased battery capacity.

In an aspect, an insulating sheet 600 is arranged between the tab connection portion 1 and the core pack 500. The insulating sheet 600 provides insulation to isolate the tab connection portion 1 from the core pack 500, thereby preventing short circuits in the core pack 500 caused by direct contact between the tab connection portion 1 and the core pack 500.

However, since the battery 1000 employs welding between the tab 501 and the tab connection portion 1, the heat generated during welding can easily transfer to the core pack 500. Therefore, during the welding process, there exists a risk that the core pack 500 may get burned, leading to short circuits in the core pack 500. To prevent the heat generated during welding between the tab connection portion 1 and the tab 501 from easily transferring to the core pack 500, and to avoid burning the core pack 500 and causing short circuits in the core pack 500, it is necessary to increase the thickness of the tab connection portion 1. However, existing connection pieces are formed by bending a plate material, resulting in connection pieces with uniform thickness. If the tab connection portion 1 is thickened, the pole connection portion 2 will also be thickened accordingly. This leads to low utilization of the internal space of the housing 700 in a height direction, thereby reducing the battery capacity.

As shown in FIG. 1 to FIG. 5, the present disclosure provides a connection structure 100 for use in the battery of the present disclosure. The connection structure 100 includes a tab connection portion 1 and a pole connection portion 2 that are bend-connected. One side of the tab connection portion 1 adjacent to the pole connection portion 2 is arranged facing the core pack 500, while one side of the tab connection portion 1 is configured to be welded with the tab 501 protruding from the core pack 500, while the pole connection portion 2 is configured to be welded to the pole 300. The thickness of the tab connection portion 1 is greater than that of the pole connection portion 2, so that a distance from the tab 501 welded to the tab connection portion 1 to a side surface of the core pack 500 where the tab 501 is located is greater than the thickness of the pole connection portion 2. The greater the welding thickness, the slower the heat transfer during welding. Therefore, by making the thickness of the tab connection portion 1 greater than the pole connection portion 2, the increased thickness of the tab connection portion 1 helps reduce heat transfers to the core pack 500 during welding, thereby minimizing the risk of burn-induced short circuits in the core pack 500. Meanwhile, keeping the pole connection portion 2 thinner avoids increasing the internal space occupied by the pole connection portion 2 within the housing 700 due to thickening of the pole connection portion 2. Thus, this design maximizes the height-direction space utilization within the housing 700 of the battery while effectively preventing welding heat from transferring to the core pack 500.

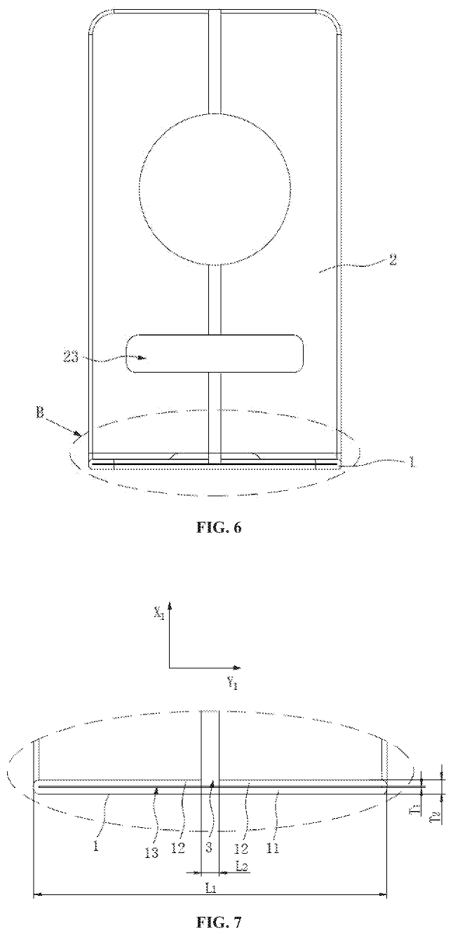

As shown in FIG. 6 and FIG. 7, the tab connection portion 1 includes a first substrate 11. Along a thickness direction (i.e., a direction X1 shown in the figures) of the tab connection portion 1, at least one side of the first substrate 11 is arranged a first plate 12 at an interval. The first substrate 11 and the first plate 12 are formed by bending a plate material, forming a heat insulation cavity 13 between the first substrate 11 and the first plate 12. In an aspect where the tab connection portion 1 is inserted into the insertion slot 502, in one implementation, one side of the first substrate 11 adjacent to the pole connection portion 2 is provided with the first plate 12, while one side surface of the first substrate 11 facing away from the first plate 12 is configured to connect with the tab 501 of the core pack 500. In another implementation, one side of the first substrate 11 facing away from the pole connection portion 2 is provided with the first plate 12, while one side surface of the first plate 12 facing away from the first substrate 11 is configured to connect the tab 501 of the core pack 500. In other words, the tab connection portion 1 is formed with a folded structure by bending, so as to achieve increased thickness of the tab connection portion 1 while avoiding thickening of the pole connection portion 2. Moreover, the heat insulation cavity 13 is formed between the first substrate 11 and the first plate 12 that are spaced apart. The heat insulation cavity 13 can reduce the transfer rate of heat generated during welding between the tab connection portion 1 and the tab 501 of the core pack 500, so as to minimize the heat transfers to the core pack 500 as much as possible, thereby reducing burn-induced short circuit damage of the core pack 500 and improving the battery production yield. Meanwhile, during battery operation, the heat insulation cavity 13 allows the electrolyte inside the housing 700 to flow through, thereby improving the electrolyte filling efficiency and the wetting effect of the core pack 500, and consequently enhancing the battery performance.

It should be noted that, the first substrate 11 is inserted into the insertion slot 502 of the core pack 500, one side of the first substrate 11 adjacent to the pole connection portion 2 is provided with the first plate 12, and one side surface of the first substrate 11 facing away from the first plate 12 is welded with the second segment 5012 of the tab 501. Certainly, without considering space utilization inside the housing 700, the tab connection portion 1 may also be arranged on one side surface of the second segment 5012 of the tab 501 facing away from the core pack 500, one side of the first substrate 11 adjacent to the pole connection portion 2 is provided with the first plate 12, and one side surface of the first plate 12 facing away from the first substrate 11 is welded with one side surface of the second segment 5012 facing away from the core pack 500.

In an aspect, as shown in FIG. 5 to FIG. 8, two ends of the first substrate 11 in its width direction (i.e., a direction Y1 in the figures) are respectively connected to two first plates 12. The two first plates 12 are located at the same side of the first substrate 11, and are arranged with an interval between them to form an opening 3 that communicates with the heat insulation cavity 13. In other words, the relative two ends of the tab connection portion 1 along its width direction (i.e., the direction Y1 in the figures) are respectively folded toward a center to form two folded portions arranged symmetrically. An interval is maintained between the two folded portions to form the opening 3, so as to prevent overlapping of the two folded portions during bending that would cause an increase in thickness of the tab connection portion 1, thereby avoiding a situation where an actual thickness of the tab connection portion 1 is inconsistent with the designed thickness and consequently the tab connection portion 1 cannot be inserted into and matched with the insertion slot 502 on the core pack 500. Moreover, during battery operation, the electrolyte can directly flow between the heat insulation cavity 13 and the core pack 500 through the opening 3, which helps shorten the flow path of the electrolyte, improving the electrolyte filling efficiency and the wetting effect of the core pack 500.

Certainly, in other embodiments, one end of the tab connection portion 1 away from the pole connection portion 2 may also be folded toward the other end along a “Z”-shaped path to form a first folded structure, which is formed with a folded portion.

In an aspect, the heat insulation cavity 13 has a thickness T₁, the tab connection portion 1 has a thickness T₂, and the tab 501 has a thickness T₃, where

$$0.1 * {T}_{3} \leq \frac{{T}_{1}}{{T}_{2}} \leq 5 * {T}_{3} .$$

An excessive thickness of the heat insulation cavity 13 would increase the space occupied by the tab connection portion 1 inside the housing 700, while an insufficient thickness of the heat insulation cavity 13 would reduce the heat insulation effect of the heat insulation cavity 13. This design determines the thickness of both the heat insulation cavity 13 and the tab connection portion 1 based on a total stacked thickness of the tab connection portion 1 and the tab 501, as well as the thickness of the tab 501, so as to minimize the spatial occupation of the tab connection portion 1 within the housing 700 while ensuring the heat insulation effect of the heat insulation cavity 13, thereby improving the utilization rate of the internal space of the housing 700.

Specifically, the side surface of the first substrate 11 facing away from the first plate 12 is welded to the tab 501. The side surface of first substrate 11 facing away from the first plate 12 includes a welding region and a non-welding region. The welding region is configured to connect with the tab 501 of the core pack 500. The first plate 12 at least partially overlaps with the welding region, so as to block heat transfer during welding and reduce heat transfer speed. The opening 3 is aligned with the non-welding region, to minimize the heat transfer directly to the core pack 500 through the opening 3.

In an aspect, the first substrate 11 has a width L₁, the opening 3 has a width L₂, where

$$\frac{{L}_{1}}{3} \geq {L}_{2} \geq 0.1 mm ,$$

and 0.8 mm≥L₂≥0.1 mm. In this aspect, L₂ is 0.1 mm, 0.2 mm, 0.3 mm, 0.4 mm, 0.5 mm, 0.6 mm, 0.7 mm, 0.8 mm, etc. An excessive width of the opening 3 would reduce the area of the welding region, resulting in a smaller welding area between the tab connection portion 1 and the tab 501, which would affect the current-carrying capacity between the tab 501 and the tab connection portion 1. Conversely, an insufficient width of the opening 3 would impede electrolyte flow, adversely affecting the wetting effect of the core pack 500. This design ensures the welding area between the tab connection portion 1 and the tab 501 while maximizing electrolyte flow efficiency, thereby balancing the wetting effect and current-carrying capacity of the core pack 500, thereby ensuring the usage performance of the battery.

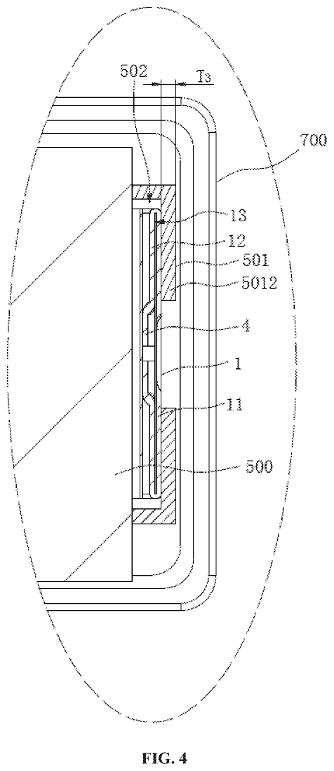

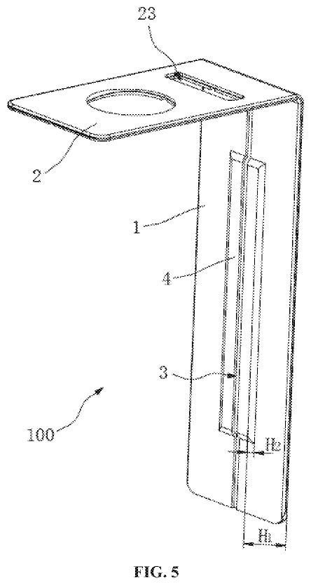

Specifically, as shown in FIGS. 4, 5 and 8, one side surface of the first plate 12 facing the core pack 500 and facing away from the first substrate 11 protrudes with a convex structure 4. A position of the convex structure 4 corresponds to a position of the non-welding region. When the tab connection portion 1 is inserted into the insertion slot 502, the convex structure 4 can be insulated against the connection surface of the core pack 500 through the insulating sheet 600, thereby spacing the welding region apart from the core pack 500. At the same time, the side surface of the first substrate 11 facing away from the core pack 500 is attached to the second segment 5012 of the tab 501. In this way, lateral movement of the tab connection portion 1 is restricted within the insertion slot 502, so as to facilitate welding between the first substrate 11 and the tab 501, at the same time, separation between the first substrate 11 and the core pack 500 can also be maintained, so as to prevent damage to the core pack 500 during welding. Furthermore, the convex structure 4 can serve as a reinforcing structure, enhancing the structural strength of the connection between the tab connection portion 1 and the tab 501, and reducing the risk of deformation and damage to the tab connection portion 1.

In one aspect, the convex structure 4 is formed by stamping the tab connection portion 1.

It should be noted that in the aforementioned examples, the thickness of the tab connection portion 1 is greater than that of the pole connection portion 2, where a total thickness H₂ of the tab connection portion 1 refers to the thickness including the thickness H₁ of the convex structure 4.

In an example, the convex structure 4 has a thickness H₁, and the tab connection portion 1 has a total thickness H₂, where H₂*5≥H₁≥0.5 mm, and 5 mm≥H₂≥0.5 mm. In the present example, H₂ is 0.5 mm, 0.6 mm, 0.7 mm, 0.8 mm, 0.9 mm, 1 mm, 1.2 mm, 1.5 mm, 1.8 mm, 2 mm, 2.2 mm, 2.5 mm, 2.8 mm, 3 mm, 3.4 mm, 3.5 mm, 3.8 mm, 4 mm, 4.4 mm, 4.5 mm, 4.7 mm, 5 mm, etc. An excessive protrusion thickness of the protrusion of the convex structure 4 would increase the space occupied by the tab connection portion 1 inside the housing 700, and reduce the space utilization rate inside the housing 700. On the other hand, an insufficient thickness of the protrusion of the convex structure 4 would result in an insufficient spacing between the tab connection portion 1 and the core pack 500, causing burn damage to the core pack 500 during welding. In addition, this design ensures a sufficient heat insulation spacing between the core pack 500 and the welding region of the tab connection portion 1, while minimizing the protrusion thickness of the tab connection portion 1 as much as possible to improve the space utilization rate inside the housing 700.

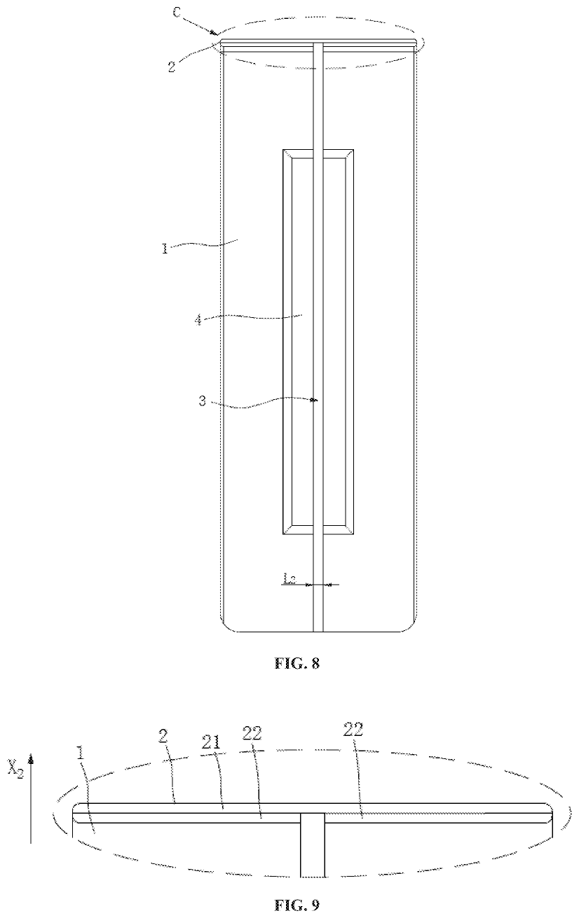

In one example, as shown in FIG. 8 and FIG. 9, the pole connection portion 2 includes a second substrate 21. Along a thickness direction (i.e., a direction X2 shown in the figures) of the pole connection portion 2, at least one side of the second substrate 21 is provided with a second plate 22. The second substrate 21 and the second plate 22 are formed by bending a plate material, so as to improve the structural strength of the pole connection portion 2.

In an example, the pole connection portion 2 and the tab connection portion 1 are integrally formed by bending from one plate material, so as to improve an overall structural strength of the connection structure 100. The pole connection portion 2 and the tab connection portion 1 are arranged vertically, that is, the entire plate is bent 90° once to form the pole connection portion 2 and the tab connection portion 1.

Since the pole connection portion 2 and the tab connection portion 1 are integrally formed by bending, thicknesses of the first substrate 11, the first plate 12, the second substrate 21 and the second plate 22 are substantially consistent. In an example, as shown in FIG. 8 and FIG. 9, at least one side of the first substrate 11 is provided with a plurality of first plates 12, and at least one side of the second substrate 21 is provided with a plurality of second plates 22, that is, the pole connection portion 2 is formed with a multi-layer folding structure by bending a plate material a plurality of times, and the pole connection portion 1 is formed with a multi-layer folding structure by bending the plate material a plurality of times. The number of the first plates 12 is greater than the number of the second plates 22, so that the total thickness of the tab connection portion 1 is greater than the total thickness of the pole connection portion 2.

In an example, the first substrate 11 and its adjacent first plate 12 are spaced apart from each other, and adjacent first plates 12 are spaced apart from each other; the second substrate 21 and its adjacent second plate 22 are attached to each other, and adjacent second plates 22 are attached to each other, so as to achieve that the total thickness of the tab connection portion 1 is greater than the total thickness of the tab connection portion 2.

In another example, the number of the first plates 12 may also be greater than the number of the second plates 22, so as to achieve that the total thickness of the tab connection portion 1 is greater than the total thickness of the pole connection portion 2.

Of course, in other examples, the first substrate 11 and its adjacent first plate 12 are spaced apart from each other, and adjacent first plates 12 are spaced apart from each other; the second substrate 21 and its adjacent second plate 22 are attached to each other, and adjacent second plates 22 are attached to each other; and the number of the first plates 12 is greater than or equal to the number of the second plates 22, so as to achieve that the total thickness of the tab connection portion 1 is greater than the total thickness of the tab connection portion 2.

As shown in FIG. 5, the pole connection portion 2 is further provided with a fuse hole 23. This design reduces a cross-sectional area of the region where the connection structure 100 is provided with the fuse hole 23, thereby increasing local resistance. When thermal runaway occurs in the battery and an abnormally high current passes through, the temperature of the connection structure 100 rises significantly, the region of the connection structure 100 provided with the fuse hole 23 will preferentially fuse due to concentrated heating, so as to rapidly break the circuit to prevent further propagation of thermal runaway, thereby enhancing the safety performance of the battery.

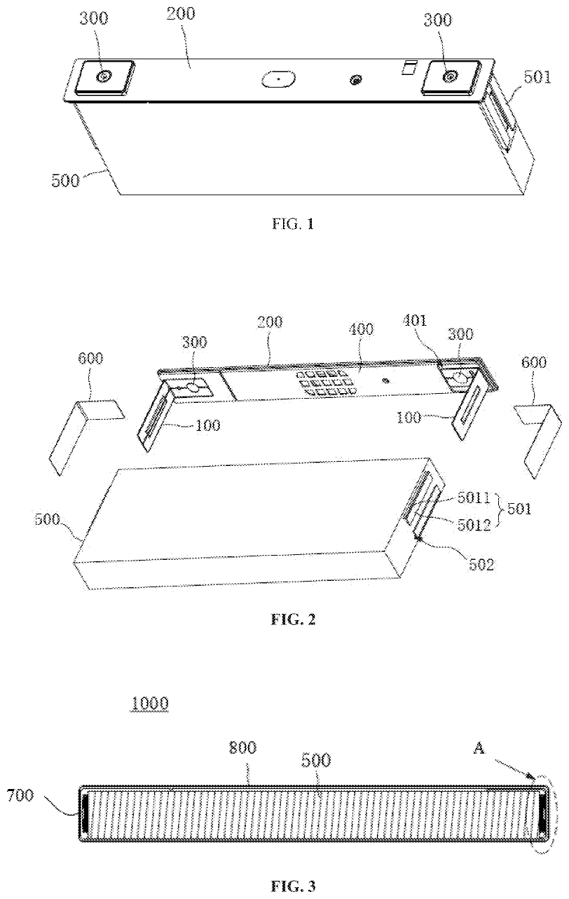

Referring to FIG. 2 again, the present disclosure further provides a cover assembly 800, which includes a cover body 200, a pole 300, a plastic member 400, and the connection structure 100 of any of the above examples. The plastic member 400 is arranged on an inner surface of the cover body 200. The plastic member 400 is provided with a through hole, and the pole 300 is mounted on the cover body 200. One end of the pole 300 extends through the through hole, while the other end of the pole 300 is located at one side of the cover body 200 facing away from the plastic member 400, that is, an outer side of the cover body 200. One side surface of the plastic member 400 facing away from the cover body 200 is further recessed to form a receiving groove 401. The through hole penetrates through a bottom of the receiving groove 401. The pole connection portion 2 of the connection structure 100 is provided within the receiving groove 401 and is connected to the pole 300. By providing the receiving groove 401, the pole connection portion 2 can be hidden in the receiving groove 401. This eliminates the need to reserve space between the core pack 500 and the plastic member 400 to accommodate the pole connection portion 2, thereby improving the space utilization inside the battery and consequently increasing the battery capacity.

What is claimed is:

1. A connection structure for connecting a core pack and a pole of a battery comprising:
a tab connection portion and a pole connection portion being bend-connected;
a side of the tab connection portion adjacent to the pole connection portion being arranged facing the core pack;
another side of the tab connection portion facing away from the pole connection portion being welded with a tab that is protruding from the core pack; and
the pole connection portion being connected with the pole, wherein
a thickness of the tab connection portion is greater than a thickness of the pole connection portion, and
a distance from the tab welded to the tab connection portion to a side surface of the core pack where the tab is located is greater than the thickness of the pole connection portion.

2. The connection structure according to claim 1, wherein
a side surface of the tab connection portion adjacent to the pole connection portion protrudes with a convex structure.

3. The connection structure according to claim 2, wherein
the convex structure is formed by stamping the tab connection portion.

4. The connection structure according to claim 1, wherein
the tab connection portion includes a first substrate;
along a thickness direction of the tab connection portion, at least one side of the first substrate is arranged with a first plate at an interval;
the first substrate and the first plate are formed by bending a plate material; and
a heat insulation cavity is formed between the first substrate and the first plate.

5. The connection structure according to claim 4, wherein
a side of the first substrate adjacent to the pole connection portion is provided with the first plate, and
a side surface of the first substrate facing away from the first plate is configured to weld with the tab of the core pack.

6. The connection structure according to claim 4, wherein
a side of the first substrate facing away from the pole connection portion is provided with the first plate,
a side surface of the first plate facing away from the first substrate is configured to weld the tab of the core pack.

7. The connection structure according to claim 5, wherein
two ends of the first substrate in width direction are respectively connected to two first plates,
the two first plates are located at a same side of the first substrate, and are arranged with an interval to form an opening that communicates with the heat insulation cavity.

8. The connection structure according to claim 7, wherein
the side surface of the first substrate facing away from the first plate comprises a welding region and a non-welding region;
the welding region is configured to connect with the tab, the first plate at least partially overlaps with the welding region; and
the opening is aligned with the non-welding region.

9. The connection structure according to claim 5, wherein
the side surface of the first substrate facing away from the first plate comprises a welding region and a non-welding region;
the welding region is configured to weld with the tab;
a side surface of the first plate facing away from the first substrate protrudes with a convex structure;
a position of the convex structure corresponds to a position of the non-welding region; and
the convex structure is configured to be insulated against a side surface of the core pack where the tab is located, and to space the welding region from the core pack.

10. The connection structure according to claim 9, wherein
the convex structure is insulated against the side surface of the core pack through an insulating sheet.

11. The connection structure according to claim 8, wherein
a side surface of the first plate facing away from the first substrate protrudes with a convex structure;
a position of the convex structure corresponds to a position of the non-welding region; and
the convex structure is configured to be insulated against a side surface of the core pack where the tab is located, and to space the welding region from the core pack.

12. The connection structure according to claim 7, wherein
the first substrate has a width L₁, the opening has a width L₂, wherein
$$\frac{{L}_{1}}{3} \geq {L}_{2} \geq 0.$$
and/or
the heat insulation cavity has a thickness T₁, the tab connection portion has a thickness T₂, and the tab has a thickness T₃, wherein
$$0.1 * {T}_{3} \leq \frac{{T}_{1}}{{T}_{2}} \leq 5 * {T}_{3} ;$$
and/or
one side surface of the first plate facing the away from the first substrate protrudes with a convex structure has a thickness H₁, and the tab connection portion has a total thickness H₂, wherein H₂*5≥H₁≥0.5 mm.

13. The connection structure according to claim 4, wherein
the pole connection portion comprises a second substrate;
a thickness direction of the pole connection portion, at least one side of the second substrate is provided with a second plate; and
the second substrate and the second plate are formed by bending the plate material.

14. The connection structure according to claim 13, wherein
the second substrate and the second plate are attached to each other; and/or
at least one side of the first substrate is provided with a plurality of the first plates, at least one side of the second substrate is provided with a plurality of the second plates, and the number of the first plates is greater than or equal to the number of the second plates.

15. The connection structure according to claim 1, wherein the pole connection portion is further provided with a fuse hole.

16. The connection structure according to claim 1, wherein the pole connection portion and the tab connection portion are integrally formed by bending from one plate material.

17. A cover assembly of a battery comprising:
a connection structure for connecting a core pack and a pole;
the connection structure including
a tab connection portion and a pole connection portion being bend-connected;
a side of the tab connection portion adjacent to the pole connection portion being arranged facing the core pack;
another side of the tab connection portion facing away from the pole connection portion being welded with a tab that is protruding from the core pack; and
the pole connection portion being connected with the pole, wherein
a thickness of the tab connection portion is greater than a thickness of the pole connection portion, and
a distance from the tab welded to the tab connection portion to a side surface of the core pack where the tab is located is greater than the thickness of the pole connection portion.

18. The cover assembly according to claim 17, further comprising:
a cover body and a plastic member;
wherein
the plastic member is arranged on an inner surface of the cover body;
the plastic member is provided with a through hole;
the pole is mounted on the cover body, and one end of the pole extends through the through hole;
one side surface of the plastic member facing away from the cover body is further recessed to form a receiving groove;
the through hole penetrates through a bottom of the receiving groove; and
the pole connection portion of the connection structure is provided within the receiving groove and is connected to the pole.

19. A battery comprising:
a housing including an opening and a core pack being arranged inside the housing, wherein the core pack is provided with a tab; and
a cover assembly including:
a connection structure for connecting the core pack and a pole;
the connection structure including
a tab connection portion and a pole connection portion being bend-connected;
a side of the tab connection portion adjacent to the pole connection portion being arranged facing the core pack;
another side of the tab connection portion facing away from the pole connection portion being welded with a tab that is protruding from the core pack; and
the pole connection portion being connected with the pole, wherein
a thickness of the tab connection portion is greater than a thickness of the pole connection portion,
a distance from the tab welded to the tab connection portion to a side surface of the core pack where the tab is located is greater than the thickness of the pole connection portion,
the cover assembly is sealed on the opening of the housing,
the tab connection portion of the connection structure of the cover assembly is connected to the tab.

20. The battery according to claim 19, wherein
the tab comprises a first segment and a second segment that are bend-connected;
one end of the first segment away from the second segment is connected to the core pack;
the core pack, the first segment and the second segment form an insertion slot;
the tab connection portion is inserted into the insertion slot;
the side of the tab connection portion facing away from the pole connection portion is welded to the second segment, and the tab connection portion is arranged insulated from the core pack.
